(19) United States
(12) Patent Application Publication
(10) Pub. No.: US 2020/0346498 A1
(43) Pub. Date: Nov. 5, 2020

(54) TIRE BEAD COMPONENT

(71) Applicants: Paul B. WINSTON, Greenville (SC); Vittoria BLASUCC, Greenville, SC (US); Compagnie Generale des Etablissements Michelin, Clermont-Ferrand (FR)

(72) Inventors: Paul B WINSTON, Greer, SC (US); Vittoria BLASUCCI, Jr., Greenville, SC (US)

(21) Appl. No.: 16/760,664

(22) PCT Filed: Oct. 31, 2017
(86) PCT No.: PCT/US17/59161

§ 371 Date: Apr. 30, 2020

(51) Int. Cl. B60C 15/06; C08L 7/00; C08L 9/00

(52) U.S. Cl. CPC B60C 15/06; C08L 7/00; B60C 2001/005; B60C 2200/06; C08L 9/00

(57) ABSTRACT

A tire having a toe guard formed of a rubber composition having between 40 phr and 70 phr of natural rubber and between 30 phr and 60 phr of a synthetic rubber component. The synthetic rubber component may be selected from the group consisting of a polybutadiene rubber (BR), a styrene butadiene rubber (SBR), a polyisoprene rubber (IR) and combinations thereof but includes an amount of BR that is between 25 wt % and 100 wt % of the total weight of the synthetic rubber component. The rubber composition further includes a reinforcing filler, a methylene donor and a methylene acceptor reinforcing resin system and a sulfur curing system having a ratio by weight of the sulfur to one or more accelerators that is less than 1.

### BACKGROUND OF THE INVENTION

### Field of the Invention

This invention relates generally to tire components of the bead section and more specifically, to rubber compositions useful for forming these components.

### Description of the Related Art

Pneumatic tires typically have a pair of spaced apart bead portions that include a bead core that is usually made of relatively inextensible metallic wires surrounded by a rubber component. A pair of opposing sidewalls portions connect with a crown portion. The crown portion typically includes one or more belt plies and a tread band. The body ply of such a tire, also referred to sometimes as the carcass or carcass ply, extends from the bead portions, through both opposing sidewall portions and the crown portion of the tire. The carcass ply or carcass plies if there is more than one, are made of cords coated with a rubber composition. The carcass constrains the inflation pressure of the tire and helps determine the overall shape of the tire upon inflation.

Since pneumatic tires are mounted on metal rims, tire designers must provide a tire having a bead area that is robust and that can withstand the forces necessary to mount and dismount a tire on the wheel rim. Especially for heavy truck tires, that are designed with carcasses that can be retreaded and have a much longer life than tires that are not designed for retreading, the rubber compounds used in the bead mounting area of the tire need to be protected from the repeated forces they undergo during mounting and remounting and during their normal service while mounted.

It is known in the industry to provide a chafer, which is an additional rubber layer, to provide additional protection of the tire in the bead area where the tire makes contact with the wheel. Often the chafer is reinforced with a woven fabric or metallic cable to help it hold its shape. However, such additional tire components increase the cost and weight of the tire.

### SUMMARY OF THE INVENTION

Particular embodiments of the inventions disclosed herein include a tire having a pair of opposing bead portions, a pair of opposing sidewall portions connected to the opposing bead portions, a crown portion connecting the opposing sidewall portions and at least one carcass extending between the bead portions and through the sidewall and crown portions. Such embodiments further include a pair of toe guards positioned around at least a radially-innermost section of each of the bead portions and extending radially outward toward the sidewall portions. These toe guards are formed of a rubber composition that is based on a cross-linkable rubber composition having, in parts by weight per 100 parts by weight of rubber (phr), between 40 phr and 70 phr of natural rubber and between 30 phr and 60 phr of a synthetic rubber component.

The synthetic rubber component may be selected from the group consisting of a polybutadiene rubber (BR), a styrene butadiene rubber (SBR), a polyisoprene rubber (IR) and combinations thereof. However, the synthetic rubber component includes an amount of BR that is between 25 wt % and 100 wt % of the total weight of the synthetic rubber component.

Particular embodiments of the inventions disclosed herein further include a reinforcing filler, a methylene donor and a methylene acceptor reinforcing resin system and a sulfur curing system comprising sulfur and one or more accelerators, wherein a ratio by weight of the sulfur to the one or more accelerators is less than 1.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 provides a schematic cross-sectional view of a bead portion of a pneumatic tire showing a toe guard.

### DETAILED DESCRIPTION OF PARTICULAR EMBODIMENTS

Embodiments of the present invention include pneumatic tires for vehicles having toe guards positioned around the radially outermost section of each of the bead portions of the tire. The toe guards provide, inter alia, protection against the forces inflicted on the bead sections upon mounting and demounting the tire from a wheel rim. Advantageously, the toe guards disclosed herein provide tire protection without the need for additional tire components, such as a chafer that can increase the weight and rolling resistance of the tire and result in a deleterious effect on fuel economy. Therefore particular embodiments of the tires disclosed herein do not include a chafer and may only include the toe guard in the tire bead area making contract with the wheel rim.

It has been found that by forming the toe guard of a tire with the rubber compositions disclosed herein, the robustness of the toe guard can be improved to provide less likelihood that a tire will be damaged during a mounting or demounting operation. Especially for tires that have a long expected life, such as those that are designed to be retreaded one or more times, the rubber compositions of those tires forming tire components that are exposed to the environment, age over time and become less pliable. Particular embodiments of the rubber compositions disclosed herein include improved characteristics that, inter alia, decrease the risk of damaging or cracking the toe guard compositions during mounting and demounting operations; e.g., reducing the high strain (100%) modulus while maintaining the low strain (10%) modulus.

For example, it is desirable in particular embodiments for the toe guard rubber compositions to have a modulus of elongation at 10% strain (MA10) to be between 5 MPa and 10 MPa or alternatively between 6.5 MPa and 9 MPa or between 7 MPa and 8 MPa, which is a desirable range for the material when the tire is in operation mounted on the rim and subjected to lower strain. During normal operation when the tire is mounted on the rim, the strain on the toe guard is low and it is therefore desirable to have a higher modulus at low strain. However, when the tire is being mounted and dismounted, it is desirable to have a lower modulus of elongation at high strain. For that condition, the modulus of elongation at 100% strain (MA100) may be, for example, between 1 MPa and 2.5 MPa or alternatively between 1.3 MPa and 2.5 MPA or between 1.5 MPA and 2 MPa, since the strain on the toe guard is high during mounting and dismounting operations.

Reference will now be made in detail to embodiments of the invention, one or more examples of which are illustrated in the drawings. Each example is provided by way of explanation of the invention. For example, features illustrated or described as part of one embodiment can be used with another embodiment to yield still a third embodiment. It is intended that the present invention include these and other modifications and variations.

The following terms are defined as follows for this disclosure:

“Axial direction” or the letter “A” in the figure refers to a direction parallel to the axis of rotation of for example, the tire and/or wheel as it travels along a road surface.

“Radial direction” or the letter “R” in the figure refers to a direction that is orthogonal to the axial direction and extends in the same direction as any radius that extends orthogonally from the axial direction.

“Equatorial plane” means a plane that passes perpendicular to the axis of rotation and bisects the outer tread band and/or wheel structure.

“Circumferential direction” or the letter “C” in the figure refers to a direction that is orthogonal to the axial direction and orthogonal to a radial direction.

“phr” means parts per hundred parts of rubber by weight “and is a common measurement in the art wherein components of a rubber composition are measured relative to the total weight of rubber in the composition, i.e., parts by weight of the component per 100 parts by weight of the total rubber(s) in the composition.

“Based upon” is a term recognizing that embodiments of the present invention are made of vulcanized or cured rubber compositions that were, at the time of their assembly, uncured. The cured rubber composition is therefore “based upon” the uncured rubber composition. In other words, the cross-linked rubber composition is based upon or comprises the constituents of the cross-linkable rubber composition.

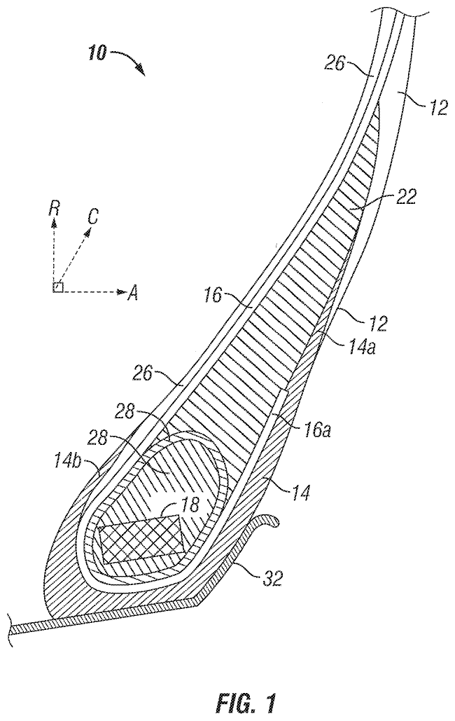

FIG. 1 provides a schematic cross-sectional view of a bead portion of a pneumatic tire showing a toe guard. The bead portion 10 of a pneumatic tire anchors the tire to the wheel rim 32 and typically includes, for example, the bead core 18 that is formed of relatively inextensible metallic wires surrounded by one or more rubber components 28. The apex 22 provides enhanced stiffness in the lower sidewall 12 of the tire. The inner liner 26 is a rubber component typically manufactured from a butyl rubber composition that covers the interior surface of the tire and helps retain the inflation air inside the tire. The carcass 16 wraps around the bead core 18 and turns up, terminating as the turned-up portion 16a of the carcass.

The toe guard 14 is positioned at the radially-innermost section of the bead portion 10 on the exterior of the tire. The toe guard is intended for contacting the rigid rim 32 of a wheel. The radially outer end 14a of the toe guard 14 is position axially at the outer surface of the tire and extends radially outward to the sidewall 12. In the embodiment shown, the end of the sidewall 12 covers the radial outer end 14a of the toe guard 14. On the interior side of the tire, the radially outer end 14b of the toe guard 14 is positioned axially at the inner surface of the tire and extends radially outward towards the inner liner 26. In the embodiment shown, the radially outer end 14b of the toe guard 14 covers the end of the inner liner 26. In other embodiments the sidewall 12 for example, may be covered by the radial outer end of the toe guard and/or the inner liner 26 may cover the radially outer end of the toe guard.

As noted above, in particular embodiments of pneumatic tires having toe guards disclosed herein, it is only the toe guard that makes contact with the wheel rim with no other tire exterior component is provided, such as a chafer, intended for contacting the rigid rim of the wheel. In some embodiments, there may be a chafer, not shown in FIG. 1, between the toe guard and the turned-up portion 16a of the carcass. The exemplary embodiment shown in FIG. 1 is not meant to limit the invention to just the embodiment presented since one skilled in the art will recognize that the bead core arrangement, the apex, the other rubber components and their arrangements, the arrangement of the toe guard ends with the ends of the sidewall and inner liner and the addition of other tire components or the removal of some of those shown are only for demonstration and can be varied by the tire designer to suit a particular design requirement.

The thickness of the toe guard may be typically, for example, between 1 mm and 5 mm or alternatively between 2 mm and 4 mm. The placement of the toe guard is, in particular embodiments, placed so that no other rubber component of the tire makes contact with the wheel rim when the tire is mounted on the rim. In other words, only the toe guard of the tire should contact the wheel rim. Therefore, the toe guard may extend, for example, about 70 mm up the side of the sidewall as measured from the toe and about 40 mm up the inner liner as measure from the toe.

As noted above, the rubber compositions disclosed herein are useful for forming the toe guards of pneumatic tires and are particularly useful in some embodiments for the toe guards on heavy vehicle tires, including heavy trucks, buses and the like. Particular embodiments of the toe guards disclosed herein are formed of a rubber composition that is based upon a cross-linkable rubber composition having rubber components that include natural rubber (NR) and polybutadiene rubber (BR). In particular embodiments, a portion of the BR may be replaced with polyisoprene rubber (IR), styrene butadiene rubber (SBR) or combinations thereof. Particular embodiments may include no SBR, other embodiments may include no IR and yet other embodiments may include no IR or SBR and only contain NR and BR. Particular embodiments may include no other rubber components other than those indicated above.

Examples of useful polyisoprene rubber include synthetic cis-1,4 polyisoprene, which may be characterized as possessing cis-1,4 bonds at more than 90 mol. % or alternatively, at more than 98 mol. %. Examples of useful SBR copolymers include, for example, those having a styrene content of between 1 wt % and 50 wt % or of between 20 wt % and 40 wt % or between 2 wt % and 35 wt % and in the butadiene faction, a content of 1,2-bonds of between 4 mol % and 65 mol %, a content of trans-1,4 bonds of between 20 mol % and 80 mol %. Examples of useful BR include those having a content of 1,2-units of between 4 mol. % and 80 mol. % or those having a cis-1,4 content of more than 80 mol. %. Natural rubber, polyisoprene rubber, styrene butadiene rubber and polybutadiene rubber are all used extensively in the tire field and are well known to those having ordinary skill in the art.

Particular embodiments of the rubber compositions disclosed herein useful for the toe guard include between 40 phr and 70 phr of natural rubber or alternatively between 45 phr and 65 phr or between 45 phr and 55 phr of natural rubber.

Particular embodiments may further include between 30 phr and 60 phr of polybutadiene or alternatively between 35 phr to 55 phr or between 45 phr and 55 phr of polybutadiene. There are embodiments of the rubber compositions disclosed herein useful for the toe guard of a tire that include no other rubber components than natural rubber and polybutadiene rubber.

In particular embodiments, in addition to the natural rubber, the rubber compositions disclosed herein may include between 30 phr and 60 phr of a synthetic rubber component or alternatively between 35 phr to 55 phr or between 45 phr and 55 phr of the synthetic rubber component, wherein the synthetic rubber component is selected from BR, IR, SBR or combinations thereof, wherein the synthetic rubber component includes an amount of BR that is between 25 wt % of the total weight of the synthetic rubber component and 100 wt % or alternatively between 50 wt % and 95 wt %, between 75 wt % and 90 wt %, between 85 wt % and 90 wt %, between 50 wt % and 100 wt %, between 75 wt % and 100 wt % or between 85 wt % and 100 wt % of the total weight of the synthetic rubber component. For example, if there is a rubber composition having 60 phr of the synthetic rubber component with 50 wt % of it as BR, then there is 30 phr of BR in the rubber composition and 30 phr of the other rubber components making up the synthetic rubber component.

In addition to the rubber components disclosed above, particular embodiments of the rubber compositions disclosed herein further include a methylene acceptor/methylene donor reinforcing resin system. Such systems include at least one methylene acceptor and at least one methylene donor. These reinforcing resin systems are well known in the art and are added to rubber compositions to increase the rigidity of the rubber compositions. Reinforcing resins intermix with the rubber polymer chains and, when reacted with a linking agent, form a three-dimensional network that improves the physical characteristics of the cured rubber composition, especially the rigidity at low strains, e.g., at <20% strain. Advantageously these reinforcing resin systems can significantly increase the MA10 modulus of elongation at low (10%) strain while having minimal effect on the MA100 modulus of elongation at high (100%) strain.

Examples of useful methylene acceptors include phenols, the generic name for hydroxylated derivatives of benzene and equivalent compounds. This definition covers in particular monophenols, for example phenol or hydroxybenzene, bisphenols, polyphenols (polyhydroxyarenes), substituted phenols such as alkylphenols or aralkylphenols, for example bisphenols, diphenylolpropane, diphenylolmethane, naphthols, cresol, t-butylphenol, octylphenol, nonylphenol, xylenol, resorcinol or analogous products and 3-hydroxydiphenyl-amine (3-HDPA) and/or 4-hydroxydiphenylamine (4-HDPA).

Useful methylene acceptors for particular embodiments are the novolac resins. These resins are phenol-aldehyde pre-condensates resulting from the condensation of phenolic compounds and aldehydes, for example formaldehyde. Novolac resins (also referred to as “two-step resins”) require the use of a methylene donor as a curing agent to crosslink the novolac resins in the rubber composition just as do the other methylene acceptors. Such crosslinking thereby creates the three dimensional resin networks. Such curing normally takes place above 100° C. An example of a suitable novolac resin is available from the SI Group with offices in Schenectady, N.Y. under the product name HRJ-12952. This novolac resin has a density of 1.25 g/cm³ and a melting point of 100° C. with less than 1% of unreacted phenol.

Particular embodiments of the rubber compositions disclosed herein include the methylene acceptor selected from a novolac resins, diphenylolmethane, diphenylolethane, diphenylolpropane, diphenylolbutane, a naphthol, a cresol or combinations thereof. Any of the methylene acceptors disclosed herein or that are otherwise known to those skilled in the art to be suitable for the purpose may be used in particular embodiments of the rubber compositions either singularly or in combination. Particular embodiments of useful rubber compositions may be limited to novolac resins as the useful methylene acceptor.

Suitable methylene donors may be selected from, for example, hexamethylenetetramine (HMT); hexamethoxymethylmelamine (HMMM); formaldehyde; paraformaldehyde; trioxane; 2-methyl-2-nitro-1-propanal; substituted melamine resins such as N-substituted oxymethylmelamine resins; glycoluril compounds such as tetramethoxymethyl glycoluril; urea-formaldehyde resins such as butylated urea-formaldehyde resins; or mixtures thereof. Hexamethylenetetramine (HMT), hexamethoxymethylmelamine (HMMM) or mixtures thereof are preferred methylene donors in particular embodiments.

The amount of methylene acceptor added to the rubber compositions disclosed herein may range, for example, from between 1 phr and 6 phr or alternatively between 1 phr and 5 phr, between 1 phr and 4 phr or between 1 phr and 3 phr. The ratio of the methylene acceptor to the methylene donor may range between 10:1 and 1:10 or alternatively between 5:1 and 2:1 or between 4:1 and 2:1.

In addition to the rubber components and the reinforcing resin system disclosed above, particular embodiments of the rubber compositions useful for the toe guards disclosed herein further includes a reinforcing filler. Reinforcing fillers are well known in the art and include, for example, carbon blacks and silica. Any reinforcing filler known to those skilled in the art may be used in the rubber composition either by themselves or in combination with other reinforcing fillers. In particular embodiments of the rubber composition disclosed herein, the filler is essentially carbon black.

Carbon black, which is an organic filler, is well known to those having ordinary skill in the rubber compounding field. The carbon black included in particular embodiments of the rubber compositions disclosed herein may range between 40 phr and 100 phr or alternatively between 40 phr and 80 phr, between 50 phr and 80 phr or between 60 phr and 70 phr.

Suitable carbon blacks are any carbon blacks known in the art and suitable for the given purpose. Particular embodiments may include carbon blacks having a surface area of between 70 m²/g and 120 m²/g or alternatively, between 100 m²/g and 120 m²/g or between 70 m²/g and 99 m²/g. The ranges for the N200 series of blacks and the N300 series of blacks are provided in ASTM Carbon blacks having a range of NSA in accordance with ASTM D-6556 Examples of useful carbon blacks include the N234, N299, N326, N330, N339, N343, N347, N375 carbon blacks.

As noted above, silica may also be useful as reinforcement filler. The silica may be any reinforcing silica known to one having ordinary skill in the art including, for example, any precipitated or pyrogenic silica having a BET surface area and a specific CTAB surface area both of which are less than 450 m²/g or alternatively, between 30 and 400 m²/g may be suitable for particular embodiments based on the desired properties of the cured rubber composition. Particular embodiments of rubber compositions disclosed herein may include a silica having a CTAB of between 80 and 200 m²/g, between 100 and 190 m²/g, between 120 and 190 m²/g or between 140 and 180 m²/g. The CTAB specific surface area is the external surface area determined in accordance with Standard AFNOR-NFT-45007 of November 1987.

Highly dispersible precipitated silicas (referred to as “HDS”) may be useful in particular embodiments of such rubber compositions disclosed herein, wherein “highly dispersible silica” is understood to mean any silica having a substantial ability to disagglomerate and to disperse in an elastomeric matrix. Such determinations may be observed in known manner by electron or optical microscopy on thin sections. Examples of known highly dispersible silicas include, for example, Perkasil KS 430 from Akzo, the silica BV3380 from Degussa, the silicas Zeosil 1165 MP and 1115 MP from Rhodia, the silica Hi-Sil 2000 from PPG and the silicas Zeopol 8741 or 8745 from Huber.

When silica is added to the rubber composition, a proportional amount of a silane coupling agent is also added to the rubber composition. The silane coupling agent is a sulfur-containing organosilicon compound that reacts with the silanol groups of the silica during mixing and with the elastomers during vulcanization to provide improved properties of the cured rubber composition. A suitable coupling agent is one that is capable of establishing a sufficient chemical and/or physical bond between the inorganic filler and the diene elastomer; which is at least bifunctional, having, for example, the simplified general formula “Y-T-X”, in which: Y represents a functional group (“Y” function) which is capable of bonding physically and/or chemically with the inorganic filler, such a bond being able to be established, for example, between a silicon atom of the coupling agent and the surface hydroxyl (OH) groups of the inorganic filler (for example, surface silanols in the case of silica); X represents a functional group (“X” function) which is capable of bonding physically and/or chemically with the diene elastomer, for example by means of a sulfur atom; T represents a divalent organic group making it possible to link Y and X.

Any of the organosilicon compounds that contain sulfur and are known to one having ordinary skill in the art are useful for practicing embodiments of the present invention. Examples of suitable silane coupling agents having two atoms of silicon in the silane molecule include 3,3′-bis(triethoxysilylpropyl) disulfide and 3,3′-bis(triethoxy-silylpropyl) tetrasulfide (known as Si69). Both of these are available commercially from Degussa as X75-S and X50-S respectively, though not in pure form. Degussa reports the molecular weight of the X50-S to be 532 g/mole and the X75-S to be 486 g/mole. Both of these commercially available products include the active component mixed 50-50 by weight with a N330 carbon black. Other examples of suitable silane coupling agents having two atoms of silicon in the silane molecule include 2,2′-bis(triethoxysilylethyl) tetrasulfide, 3,3′-bis(tri-t-butoxy-silylpropyl) disulfide and 3,3′-bis(di t-butylmethoxysilylpropyl) tetrasulfide. Examples of silane coupling agents having just one silicon atom in the silane molecule include, for example, 3,3′(triethoxysilylpropyl) disulfide and 3,3′ (triethoxy-silylpropyl) tetrasulfide. The amount of silane coupling agent can vary over a suitable range as known to one having ordinary skill in the art. Typically the amount added is between 7 wt. % and 15 wt. % or alternatively between 8 wt. % and 12 wt. % or between 9 wt. % and 11 wt. % of the total weight of silica added to the rubber composition.

In addition to the rubber components, the reinforcing resin system and the reinforcement fillers disclosed above, particular embodiments of the rubber compositions useful for the toe guards disclosed herein further include a sulfur curing system comprising sulfur and one or more accelerators. In particular embodiments, the curing system is an efficient curing system, i.e., the ratio by weight of sulfur to the accelerators is less than 1. Particular embodiments may have a ratio of sulfur to accelerators having a range of between 0.1 and 0.8, between 0.15 and 0.6, between 0.2 and 0.5 or between 0.3 and 0.4. In a rubber composition that includes silica, diphenyl guanidine (DPG) is often added so that the reaction between the silane coupling agent yet still acts as an accelerator and would be taken into account with the sulfur to accelerator ratio.

As known by those skilled in the art, sulfur may take the form of free sulfur, insoluble sulfur, soluble sulfur and/or provided by a sulfur donor. Sulfur donors, as known in the art, contribute sulfur to the curing process. An example of a sulfur donor is caprolactam disulfide, which is sold under the trade name RHENOGRAN CLD-80 by Lanxess. In particular embodiments, sulfur may be added in an amount ranging between 0.3 and 3 phr or alternatively between 0.5 phr and 2 phr or between 0.5 and 1.5 phr.

Accelerators are well known and typically are chosen from the basic families of accelerators based on their speed of vulcanization: guanidines (medium) such as diphenyl guanidine (DPG); thiazoles (semi-fast) such as 2-mercaptobenzothiazole (MBT) and 2-mercaptobenzothiazyl disulfide (MBTS); sulphenamides (fast) such as N-cyclohexyl-2-benzothiazolesulphenamide (CBS), N,N-dicyclohexyl-2-benzothiazolesulphenamide (DCBS) and N-tert-butyl-2-benzothiazole-sulphenamide (TBBS); thiurams (very fast) such as tetramethylthiuram monosulfide (TMTM); and dithiocarbamates (super-fast) such as zinc dimethyldithiocarbamate (ZDMC) and zinc diethyldithiocarbamate (ZDEC).

The vulcanization system may further include various known vulcanization activators, such as zinc oxide and stearic acid.

Other additives can be added to the rubber compositions disclosed herein as known in the art. Such additives may include, for example, some or all of the following: antidegradants, antioxidants, fatty acids, waxes, stearic acid and zinc oxide. Examples of antidegradants and antioxidants include 6PPD, 77PD, IPPD, DAPD and TMQ and may each be added to rubber compositions in an amount, for example, of from 0.5 phr and 7 phr. Zinc oxide may be added in an amount, for example, of between 1 phr and 6 phr or alternatively, of between 1.5 phr and 4 phr. Stearic acid may be added in an amount, for example, of between 1 phr and 4 phr or alternatively between 1 phr and 2 phr. Waxes may be added in an amount, for example, of between 0.5 phr and 5 phr or alternatively between 0.5 phr and 1.5 phr.

In particular embodiments of the rubber composition, in addition to the elastomers, reinforcing fillers, reinforcing resin systems, sulfur and accelerators disclosed above, particular amounts of the protection system may include, for example between 5 phr and 10 phr of antioxidants. An example of one embodiment of the rubber composition may include between 5 phr and 6 phr of 6PPD and between 3 phr and 5 phr of TMQ.

The rubber compositions that are embodiments of the present invention may be produced in suitable mixers, in a manner known to those having ordinary skill in the art, typically using two successive preparation phases, a first phase of thermo-mechanical working at high temperature, followed by a second phase of mechanical working at lower temperature.

The first phase of thermo-mechanical working (sometimes referred to as “non-productive” phase) is intended to mix thoroughly, by kneading, the various ingredients of the composition, with the exception of the vulcanization system. It is carried out in a suitable kneading device, such as an internal mixer or an extruder, until, under the action of the mechanical working and the high shearing imposed on the mixture, a maximum temperature generally between 120° C. and 190° C., more narrowly between 130° C. and 170° C., is reached.

After cooling of the mixture, a second phase of mechanical working is implemented at a lower temperature. Sometimes referred to as “productive” phase, this finishing phase consists of incorporating by mixing the vulcanization (or cross-linking) system (sulfur or other vulcanizing agent and accelerator(s)), in a suitable device, for example an open mill. It is performed for an appropriate time (typically between 1 and 30 minutes, for example between 2 and 10 minutes) and at a sufficiently low temperature lower than the vulcanization temperature of the mixture, so as to protect against premature vulcanization.

The rubber compositions can then be formed into useful articles, including tire components such as the toe guard of a tire, and cured.

The invention is further illustrated by the following examples, which are to be regarded only as illustrations and not delimitative of the invention in any way. The properties of the compositions disclosed in the examples were evaluated as described below and these utilized methods are suitable for measurement of the claimed properties of the claimed invention.

Modulus of elongation (MPa) was measured at 10% (MA10) or 100% (MA100) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

The elongation property was measured as elongation at break (%) and the corresponding elongation stress (MPa), which is measured at 23° C. in accordance with ASTM Standard D412 on ASTM C test pieces.

The tear resistance indices are measured at 23° C. The breaking load (FRD) is in N/mm of thickness and the elongation at break (ARD) in percentage are measured on a test piece of dimensions 10×142×2.5 mm notched with 3 notches that each have a depth of 3 mm. The tear resistance index is then provided by the following equation:

TR=(FRD*ARD)/100.

To determine aged properties, samples are first aged for 28 days at 77° C.

### Example 1

Rubber compositions were prepared using the components shown in Table 1. The amount of each component making up the rubber compositions are provided in parts per hundred part of rubber by weight (phr).

The carbon black was N299 having a surface area of 105 m²/g (surface areas being NSA in accordance with ASTM D-6556). The methylene acceptor was a formophenloic resin from SI Group HRJ 12952 and the methylene donor was hexamethylenetetramine (HMT). The sulfur was element sulfur and the accelerator was CBS. The protection system included wax, 6PPD and TMQ. The SBR had a styrene content of 26%.

The rubber formulations were prepared by mixing the components given in Table 1, except for the accelerators and sulfur, in a Banbury mixer until a temperature of between 110° C. and 170° C. was reached. The accelerators and sulfur were added in the second phase on a mill. Vulcanization was effected at 150° C. for 25 minutes. The formulations were then tested to measure their properties, the results of which are shown in Table 2.

TABLE 1
Formulations

| Components | W1 | W2 | W3 | F1 | F2 |
|---|---|---|---|---|---|
| NR | 50 | 25 | 50 | 50 | 50 |
| BR | 50 | 75 | 25 | 50 | 50 |
| SBR | | | 25 | | |
| N299 | 60 | 65 | 60 | 60 | 60 |
| Process Oil | 2 | 4 | | 2 | 2 |
| Methylene acceptor | 0 | 0 | 0 | 2 | 4 |
| HMT | 0 | 0 | 0 | 0.64 | 1.28 |
| Stearic Acid | 1.5 | 3 | 3 | 1.5 | 1.5 |
| Zinc Oxide | 4 | 4 | 4 | 4 | 4 |
| 6PPD | 5.5 | 3 | 3 | 5.5 | 5.5 |
| TMQ | 3.5 | 2 | 2 | 3.5 | 3.5 |
| Wax | 1 | 1 | 1 | 1 | 1 |
| Accelerator | 1.8 | 1.3 | 1.5 | 1.8 | 1.8 |
| Sulfur | 0.6 | 1.3 | 0.5 | 0.6 | 0.6 |
| S/A ratio, by weight | 0.33 | 1 | 0.33 | 0.33 | 0.33 |

As can be seen from Table 2, carbon black can be used to increase the MA10 rigidity but, as can be seen between W1 and W2, it also increases the MA100 rigidity. However, using the reinforcing resin system provides an increased MA10 rigidity without a significant increase in the MA100 rigidity.

TABLE 2
Physical Properties

| Physical Properties | W1 | W2 | W3 | F1 | F2 |
|---|---|---|---|---|---|
| MA10, MPa | 5.2 | 7.42 | 6.1 | 7.34 | 8.2 |
| MA10 aged, MPa | 8.3 | 12.1 | 8.8 | 9.78 | 12.8 |
| MA100, MPa | 1.7 | 2.6 | 1.7 | 1.69 | 1.7 |
| MA100 aged, MPa | — | 4.8 | — | 2.58 | — |
| Strain at Break @ | 573 | 447 | 618 | 564 | 564 |
| 23° C., % | | | | | |
| Strain at Break aged | — | 250 | — | 405 | — |
| @ 23° C., % | | | | | |

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A tire defining a radial direction, an axial direction and a circumferential direction, the tire comprising:
a pair of opposing bead portions;
a pair of opposing sidewall portions connected to the opposing bead portions;
a crown portion connecting the opposing sidewall portions;
at least one carcass extending between the bead portions and through the sidewall and crown portions; and
a pair of toe guards positioned around at least a radially-innermost section of each of the bead portions and extending radially outward toward the sidewall portions, wherein the toe guards are formed of a rubber composition based upon a cross-linkable rubber composition, the cross-linkable rubber composition comprising, in parts by weight per 100 parts by weight of rubber (phr):
between 40 phr and 70 phr of natural rubber;
between 30 phr and 60 phr of a synthetic rubber component selected from the group consisting of a polybutadiene rubber (BR), a styrene butadiene rubber (SBR), a polyisoprene rubber (IR) and combinations thereof, wherein the synthetic rubber component includes the BR in an amount that is between 25 wt % and 100 wt % of the total weight of the synthetic rubber component;
a reinforcing filler;
a methylene donor and a methylene acceptor reinforcing resin system; and
a sulfur curing system comprising sulfur and one or more accelerators, wherein a ratio by weight of the sulfur to the one or more accelerators is less than 1.

2. The tire of claim 1, wherein the cross-linkable rubber composition comprises between 45 phr and 65 phr of the synthetic rubber component.

3. The tire of claim 1, wherein the rubber component includes no polyisoprene.

4. The tire of claim 1, wherein the cross-linkable rubber composition further comprises between 40 phr and 100 phr of a reinforcing filler.

5. The tire of claim 4, wherein the reinforcing filler is a carbon black having a nitrogen surface area of between 70 m²/g and 120 m²/g.

6. The tire of claim 1, wherein the cross-linkable rubber composition includes between 1 phr and 6 phr of the methylene acceptor.

7. The tire of claim 1, wherein the methylene acceptor is selected from group consisting of phenol, bisphenols, polyphenols, substituted phenols, cresol, t-butylphenol, octylphenol, nonylphenol, xylenol, resorcinol, a novolac resin and combinations thereof.

8. The tire of claim 1, wherein the methylene acceptor is the novolac resin.

9. The tire of claim 1, wherein the methylene donor is selected from the group consisting of hexamethylenetetramine (HMT), hexamethoxymethylmelamine (HMMM) and combinations thereof.

10. The tire of claim 1, wherein the sulfur to accelerator ratio is between 0.3 and 0.6.

11. The tire of claim 1, wherein the cross-linkable rubber composition further comprises a protection package comprising between 8 phr and 11 phr of one or more antioxidants.

12. The tire of claim 11, wherein the one or more antioxidants are 6PPH and TMQ.

13. The tire of claim 1, wherein the cross-linkable rubber composition further comprises between 1 phr and 2 phr of stearic acid.

14. The tire of claim 1, wherein a modulus of elongation of the rubber composition measured at 23° C. at 10% strain (MA10) is between 6.5 MPa and 9 MPa and a modulus of elongation measured at 23° C. at 100% strain (MA100) is between 1 MPa and 2.5 MPa.

15. The tire of claim 1, wherein the rubber composition includes only the NR and the synthetic rubber component as rubber components.

16. The tire of claim 14, wherein the tire is a heavy truck tire.

17. A tire defining a radial direction, an axial direction and a circumferential direction, the tire comprising:
a pair of opposing bead portions;
a pair of opposing sidewall portions connected to the opposing bead portions;
a crown portion connecting the opposing sidewall portions;
at least one carcass extending between the bead portions and through the sidewall and crown portions; and
a pair of toe guards positioned around at least a radially-innermost section of each of the bead portions and extending radially outward toward the sidewall portions, wherein the toe guards are formed of a rubber composition based upon a cross-linkable rubber composition, the cross-linkable rubber composition comprising, in parts by weight per 100 parts by weight of rubber (phr):
between 40 phr and 70 phr of natural rubber;
between 45 phr and 65 phr of a synthetic rubber component selected from the group consisting of a polybutadiene rubber (BR), a styrene butadiene rubber (SBR), a polyisoprene rubber (IR) and combinations thereof, wherein the synthetic rubber component includes the BR in an amount that is between 25 wt % and 100 wt % of the total weight of the synthetic rubber component;
between 40 phr and 100 phr of a reinforcing filler, wherein the reinforcing filler is a carbon black having a nitrogen surface area of between 70 m²/g and 120 m²/g;
a methylene donor and a methylene acceptor reinforcing resin system, wherein the cross-linkable rubber composition includes between 1 phr and 6 phr of the methylene acceptor; and
a sulfur curing system comprising sulfur and one or more accelerators, wherein a ratio by weight of the sulfur to the one or more accelerators is less than 1.

18. The tire of claim 17, wherein the sulfur to accelerator ratio is between 0.3 and 0.6.

19. The tire of claim 17, wherein the cross-linkable rubber composition further comprises a protection package comprising between 8 phr and 11 phr of one or more antioxidants.

20. The tire of claim 19, wherein the one or more antioxidants are 6PPH and TMQ.
